(19) United States
(12) Patent Application Publication
(10) Pub. No.: US 2013/0224989 A1
(43) Pub. Date: Aug. 29, 2013

(54) CABLE STRAIN RELIEF

(71) Applicant: Stefan Giefers, Detmold (DE)

(72) Inventor: Stefan Giefers, Detmold (DE)

(73) Assignee: PHOENIX CONTACT GMBH & CO. KG, Blomberg (DE)

(21) Appl. No.: 13/819,223

(22) PCT Filed: Aug. 25, 2011
(86) PCT No.: PCT/EP11/64676

§ 371 Date: May 7, 2013

(30) Foreign Application Priority Data
Aug. 27, 2010 (DE) 10 2010 037 193.9

(51) Int. Cl. H02G 15/007; H02G 3/22

(52) U.S. Cl. CPC H02G 15/007; H02G 3/22
USPC 439/452; 174/650; 174/135

(57) ABSTRACT

The invention relates to a cable strain relief for a cable. The cable strain relief comprises a strain relief element (20) and a retaining element (10). The retaining element (10) is intended to be connected to a mating piece (40). The strain relief element (20) and the retaining element (10) are designed such that said elements form a unit (1). The invention further relates to a connector set and a feedthrough set, which comprises an aforementioned cable strain relief (10, 20) and a mating piece (40). The mating piece (40) is intended to be connected to the retaining element (10) of the cable strain relief (10, 20), wherein the mating piece can be pushed onto a cable.

The invention relates to a cable strain relief.

Cable strain reliefs are currently used on the market in many kinds of embodiments.

A large number of these cable strain reliefs are formed in a screwable manner.

In addition to strain relief, a sealing function is also to be met in a range of fields of application so that the cable strain relief can also be used in fields in which an entry of conducting fluids or conducting dusts is undesirable. Such fields include, for example, plant construction, connection of photovoltaic systems and also automotive engineering.

Known cable strain reliefs are formed in a number of parts, and therefore the individual parts have to be joined together by the user. Since the individual parts are loose, positioning errors may occur during the assembly process so that the necessary tightness is not achieved, and these cable strain reliefs may also tend to come loose under external stress, such as temperature fluctuations and vibrations, thus leading to a loosening of the seal.

This problem also occurs if merely one cable strain relief is to be used for a large number of different cables. In this case, the requirements to cover a broad cable spectrum with simultaneous tightness and necessary strain relief often conflict with one another.

In order to overcome this dilemma, different ring seals were included in the past. Disadvantages of this are that a large number of seals have to be included and therefore the cost advantage of a standardised cable strain relief is lost, and also that this approach is susceptible to error, since in this case the matching seal has to be picked and assembled for the respective cable type. Both the retrieval and assembly of a losable seal are susceptible to error.

The object of the invention is therefore to provide a cable strain relief that solves a disadvantage or a plurality of disadvantages from the prior art in an inventive manner.

The object is achieved by a cable strain relief for a cable. The cable strain relief comprises a strain relief element and a retaining element. The retaining element is intended to be connected to a mating piece. The strain relief element and the retaining element are designed such that they form a unit.

In a further embodiment of the invention the strain relief element is provided crown-like. In a development of the invention the strain relief element comprises a cylindrical, resilient insert.

In yet a further embodiment of the invention the strain relief element comprises a stop face such that a seal is achieved in the assembled state.

In yet a further development of the invention the retaining element and the strain relief element comprises latching elements so that the retaining element and the strain relief element can be connected in a latching manner.

In a further development of the invention the retaining element and the strain relief element form a unit.

In a development of the invention the retaining element is proveds as a cap nut.

The object is also achieved by a plug connector set, which has a cable strain relief as described previously and a mating piece. The mating piece is intended to be connected to the retaining element of the cable strain relief, wherein the mating piece can be slid onto a cable.

The object is also achieved by a feedthrough set, which has a cable strain relief as described previously and a mating piece. The mating piece is intended to be connected to the connected retaining element of the cable strain relief, wherein the mating piece can be fixed in a housing and can be slid onto a cable.

The invention will be explained in greater detail hereinafter with reference to the accompanying drawings on the basis of preferred embodiments.

In the drawings:

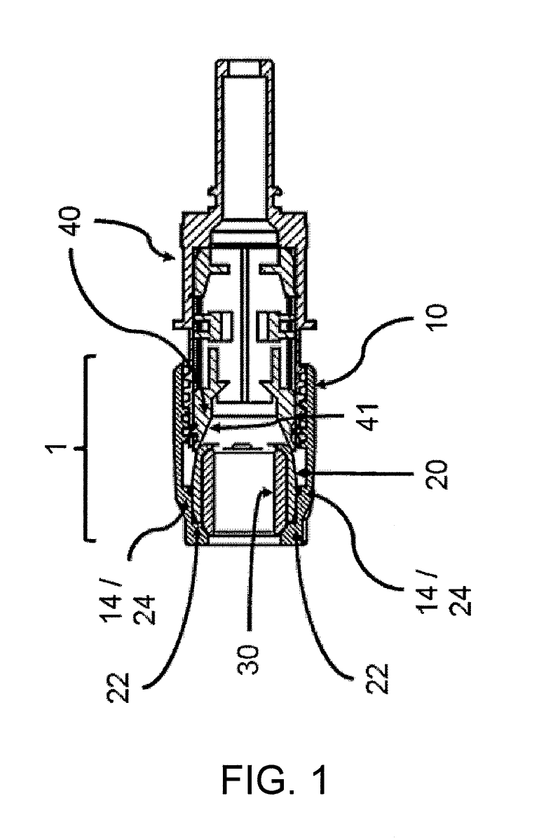

FIG. 1 shows a sectional view of a cable strain relief according to the invention,

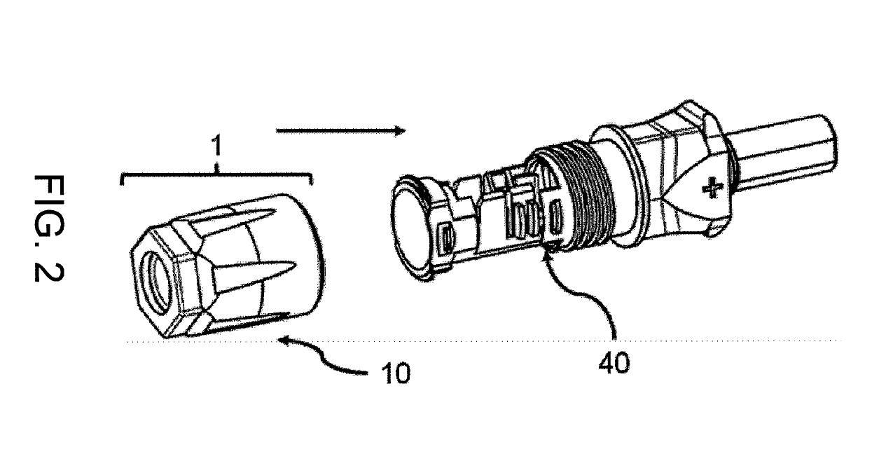

FIG. 2 shows a perspective illustration of a cable strain relief according to the invention, and

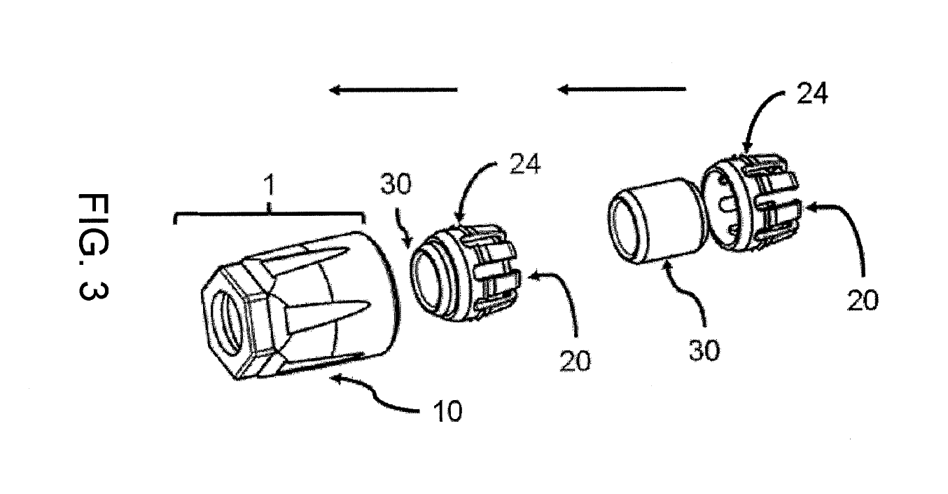

FIG. 3 shows a further perspective illustration of a retaining element of a cable strain relief according to the invention.

The figures show a cable strain relief according to the invention. Although a cable strain relief is illustrated in the figures on the basis of a plug connector set and parts thereof, it is at all times clear to a person skilled in the art that the principle of the invention can also be applied equally to feedthrough sets and parts thereof.

A cable strain relief according to the invention is intended to be assembled on a cable. The cable strain relief has a strain relief element 20 and a retaining element 10 for this purpose. The retaining element 10 is intended to be connected to a mating piece 40.

The connection can be produced by screwing by means of a thread or by means of a bayonet closure or the like.

The strain relief element 20 and the retaining element 10 are designed such that they form a unit 1. This unit 1 can be produced as one piece or may also be produced such that the strain relief element 20 and the retaining element 10 are produced separately, but are held together captively by subsequent joining and therefore form a unit.

If the strain relief element 20 and the retaining element 10 are produced separately, but are held captively by subsequent joining, the joining process may be implemented by means of latching elements 14, 24 so that said elements can be joined in a simple manner and held captively simultaneously.

In the illustrated example according to FIGS. 1 and 2 indentations 14 are formed in the retaining element 10 and can receive corresponding protrusions 24, which are provided on the strain relief element 20, in a latching manner.

In a further embodiment of the invention the strain relief element 20 is crown-like. Due to the crown-like design, the cable strain relief can be used over a wide range of cable diameters. Due to the alignment of the strain relief element 20, it is also possible for strain at the cable to be taken up reliably, since in this embodiment an improved distribution of force is enabled.

In a development of the invention the strain relief element 20 has a cylindrical, resilient insert 30. This insert 30 seals the cable substantially.

Due to the embodiment according to the invention the cable strain relief can be used over a wide range of cable diameters without the need to change seals. As a result, the production cost is minimised and increased security against error during the assembly process is also enabled. This is made possible since the strain relief element 20 is deformable and the mating piece 40 has an inclined stop face 41, so that the strain relief element 20 is deformed when the mating piece 40 and the unit 1 are assembled, thus reducing the diameter for a cable feedthrough. The deformation itself may also comprise radial deformation in addition to axial deformation.

If the strain relief element 20 with the cylindrical resilient insert 30 (as shown in FIG. 3) is inserted into the retaining element 10, this thus forms a unit 1.

As already described, the strain relief element 20 and the retaining element 10 may be formed in one piece and thus already produced as a unit 1.

Alternatively, the cylindrical, resilient insert 30 may also be inserted into a unit 1 formed of the strain relief element 20 and the retaining element 10.

In yet a further embodiment of the invention the strain relief element 20 has a stop face 22 such that a seal is achieved when the unit is assembled.

The access path of dust and/or fluids is thus also prevented as a result of this measure.

The retaining element 10 is illustrated as a cap nut. The mating piece then accordingly also contains a matching thread so that the cooperation between the cap nut and the mating piece provides a reliable cable strain relief for different cable diameters.

Alternatively, the invention can also be formed as a feedthrough set with utilisation of the same principles. Of course, the mating piece in said feedthrough set may then be fixed in a housing.

In an advantageous production method the retaining element 10 and the mating piece 40 are produced from a thermoplastic material, for example by means of injection moulding.

The strain relief element 20 can also be produced form a thermoplastic material.

Alternatively, other materials, in particular including conductive materials, can also be used, for example if a shielding has to be transferred.

### LIST OF REFERENCE SIGNS

unit 1

retaining element 10

latching element 14

strain relief element 20

stop face 22

latching element 24

cylindrical, resilient

insert 30

mating piece 40

inclined stop face 41

1. A cable strain relief for a cable, having a strain relief element (20) and a retaining element (10), wherein the retaining element (10) is provided as a cap nut and is intended to be connected to a mating piece (40), characterised in that the strain relief element (20) and the retaining element (10) are designed such that they form a unit (1).

2. The cable strain relief according to claim 1, characterised in that the strain relief element (20) is provided crown-like.

3. The cable strain relief according to claim 1, characterised in that the strain relief element (20) comprises a cylindrical, resilient insert (30).

4. The cable strain relief according to claim 1, characterised in that the strain relief element (20) comprises a stop face (22) such that a seal is achieved in the assembled state.

5. The cable strain relief according to claim 1, characterised in that the retaining element (10) and the strain relief element (20) comprises latching elements (14, 24) so that the retaining element (10) and the strain relief element (20) can be connected in a latching manner.

6. The cable strain relief according to claim 1, characterised in that the retaining element (10) and the strain relief element (20) form a unit (1).

7. (canceled)

8. A plug connector set, characterised by a cable strain relief According to claim 1 and a mating piece (40), which is intended to be connected to the retaining element of the cable strain relief, wherein the mating piece (40) can be slid onto a cable.

9. A feedthrough set, characterised by a cable strain relief according to claim 1 and a mating piece (40), which is intended to be connected to the connected retaining element of the cable strain relief, wherein the mating piece (40) can be fixed in a housing and can be slid onto a cable.
